(19) United States
(12) Patent Application Publication
(10) Pub. No.: US 2025/0018823 A1
(43) Pub. Date: Jan. 16, 2025

(54) ON-SITE DEVICE TO DIAGNOSE AND RECOVER OFFLINE NETWORKED ELECTRIC VEHICLE SUPPLY EQUIPMENTS (EVSES)

(71) Applicant: Siemens Industry, Inc., Alpharetta, GA (US)

(72) Inventors: Sesha Devasena Yeruva, Duluth, GA (US); Elton C. Johnson, Decatur, GA (US); Megan Jarriel, Atlanta, GA (US)

(73) Assignee: Siemens Industry, Inc., Alpharetta, GA (US)

(21) Appl. No.: 18/350,297

(22) Filed: Jul. 11, 2023

(51) Int. Cl. B60L 53/68; B60L 53/63

(52) U.S. Cl. CPC B60L 53/68; B60L 53/63

(57) ABSTRACT

An on-site device configured to be used with networked Electric Vehicle Supply Equipments (EVSEs) is provided to diagnose or recover an EVSE for configuration. The on-site device comprises a first coupler interface configured to electrically connect the on-site device to one or more EVSEs, a first communication interface to connect the on-site device to a short-range communication network on a wired network or on a wireless network. It further comprises a second communication interface to connect the on-site device to a long-range wireless communication network, a processor and a memory storing instructions that, when executed by the processor, cause the on-site device to: establish a communication connection with the EVSE and interface to the EVSE via a programmable logic controller (PLC) on a control pilot, Modbus RTU or other near-field communication (NFC), perform diagnostics to locally recover charging operation or network connectivity of EVSEs and further aid in remote maintenance.

### BACKGROUND

### 1. Field

Aspects of the present invention generally relate to an on-site device for use with networked Electric Vehicle Supply Equipments (EVSEs) for diagnosing and recovering them in order to manage configuration of an offline EVSE.

### 2. Description of the Related Art

Unlike gas-powered vehicles, electric vehicles (EVs) do not require internal combustion engines to operate. Outfitted with an electric motor and a rechargeable battery pack, EVs move along our roadways without burning up gasoline, or producing harmful exhaust emissions, while generating less noise pollution. The world of transportation continues to rapidly evolve. Sales of electric vehicles (EVs) are expected to expand rapidly in the US in the coming years. Economics aside, there are growing social and political initiatives toward “clean” energy that will push this to become reality. A number of market forecasts indicate electric vehicles will account for nearly 1 in 5 of all vehicles sold within the next 10 years. It is estimated approximately 3 million EVs will be sold in the US in 2028. A rule of thumb by industry analysts is there need be on the order of 20 public EVC stations per EV on the road to support the ecosystem. There were just over 60,000 charging stations in the US at the end of 2019. Thus, tens of thousands will need to be deployed every year for some time as the market grows.

Charging stations have provided hundreds of millions of charges to EV (electric vehicle) drivers worldwide. When it comes to electric vehicles, the converter is built inside the car. It's called the “onboard charger” though it really is a converter. It converts power from AC to DC and then feeds it into the car's battery. This is the most common charging method for electric vehicles today and most chargers use AC power.

An EV is connected to AC power, 120V or 240V, and a battery charger in the EV converts the AC power to the DC needed to charge the battery and controls the charging process. In DCFC the DCFC converts the AC power to DC and the DC power is sent directly to the EV battery bypassing the onboard battery charger. There are three categories or types of charging: Trickle Charge, AC Charge and DC Charge. Most drivers of electric vehicles (EVs)—which include all-electric vehicles and plug-in hybrid electric vehicles (PHEVs)—charge their vehicles overnight at home using AC Level 1 or AC Level 2 charging equipment.

A charging station, also known as a charge point or electric vehicle supply equipment (EVSE), is a piece of equipment that supplies electrical power for charging plug-in electric vehicles (including electric cars, electric trucks, electric buses, neighborhood electric vehicles, and plug-in hybrids). There are two main types: AC charging stations and DC fast chargers. Batteries can only be charged with direct current (DC) electric power, while most electricity is delivered from the power grid as alternating current (AC). For this reason, most electric vehicles have an onboard charger with an AC-to-DC converter (a rectifier). At an AC charging station, power is supplied to the onboard charger.

Capability to diagnose network capable EVSEs in the field is desired. When networked EVSEs loose connectivity to a backend, they will not send any status or diagnostics information of the charger. Remote diagnostics and further recovery mechanisms will not work in this scenario. Therefore, there is a need for a system and a method to manage configuration of an offline EVSE. Once a unit is offline, personnel at the location will need to perform Power cycle to restore connection. PC based tools, hardware diagnostic tools (oscilloscopes, spectrum analyzers) will need to be utilized for diagnosing network connectivity; units are retuned or utilized with partial functions, if connectivity to the backend is not restored.

### SUMMARY

Briefly described, aspects of the present invention relate to configuring an offline Electric Vehicle Supply Equipment (EVSE) via an on-site device capable of diagnosing and recovering networked Electric Vehicle Supply Equipments (EVSEs). Techniques for configuring electric vehicle supply equipment (EVSE) are disclosed. The disclosed embodiments describe interfacing to an EVSE via a Programmable Logic Controller (PLC) on Control pilot (Home Plug Green Phy), Modbus Remote Terminal Unit (RTU) or other near-field communication (NFC) to perform diagnostics, changes to Network characteristics, aid in predictive analytics. A diagnostic device or tool can connect to the EVSE through an Electric Vehicle (EV) coupler interface. This will allow for access to a control pilot signal and Load voltage lines when the tool simulates a charging scenario. PLC communication utilizing the Pilot line will allow to perform authentication of the tool similar to how an EV is authenticated. The tool can further request for fault data, network status, signal strength etc. Access to local diagnostic logs is also possible. These logs can be shared via a cellular network accessible on the tool for further evaluation of the non-functioning unit. The tool can also connect to a charger via RTU, NFC communication (Blue tooth, Radio-frequency identification (RFID) interface) and extract the same information described above. The tool can dynamically evaluate network issues causing loss of Internet access to unit and attempt to restore connection by restarting the networking components on board, modifying communication channel in case of congestion etc., as a recovery mechanism. The tool can be used in a breakout mode inline with the EV as well. All solutions are limited to diagnosing basic control pilot states, inducing vehicle and safety faults and capture electrical data locally. Existing tools mainly attempt to diagnose charging function anomalies. The proposed solution will diagnose networking issues that impact authorization, data reporting (status, electrical data) to backend, enable performing load control post networking issues that cause the unit to go offline.

In accordance with one illustrative embodiment of the present invention, an on-site device is configured to be used with networked Electric Vehicle Supply Equipments (EVSEs). The on-site device comprises a first coupler interface configured to electrically connect the on-site device to one or more EVSEs and a first communication interface to connect the on-site device to a short-range communication network on a wired network via Transmission Control Protocol/Internet Protocol (TCP/IP) or Remote Terminal Unit (RTU) or on a wireless network. It further comprises a second communication interface to connect the on-site device to a long-range wireless communication network, a processor and a memory storing instructions that, when executed by the processor, cause the on-site device to: establish a communication connection with the EVSE and interface to the EVSE via a programmable logic controller (PLC) on a control pilot, Modbus RTU or other near-field communication (NFC), perform diagnostics to locally recover charging operation or network connectivity of one or more EVSEs of the networked EVSEs and further aid in remote maintenance.

In accordance with one illustrative embodiment of the present invention, a method for diagnosing networked Electric Vehicle Supply Equipments (EVSEs) with an on-site device is provided. The method comprises providing a first coupler interface configured to electrically connect the on-site device to one or more EVSEs, providing a first communication interface to connect the on-site device to a short-range communication network on a wired network via Transmission Control Protocol/Internet Protocol (TCP/IP) or Remote Terminal Unit (RTU) or on a wireless network and providing a second communication interface to connect the on-site device to a long-range wireless communication network. The method further comprises providing a processor and providing a memory storing instructions that, when executed by the processor, cause the on-site device to: establish a communication connection with the EVSE and interface to the EVSE via a programmable logic controller (PLC) on a control pilot, Modbus RTU or other near-field communication (NFC), perform diagnostics to locally recover charging operation or network connectivity of one or more EVSEs of the networked EVSEs and further aid in remote maintenance.

In accordance with one illustrative embodiment of the present invention, an on-site device is configured to be used with networked Electric Vehicle Supply Equipment (EVSEs). The on-site device comprises a first interface configured to electrically connect the on-site device to one or more EVSEs of the networked EVSEs, a first communication interface to connect the on-site device to a long-range communication network to allow transfer of diagnostic data to a remote server and a second communication interface to connect the on-site device to a short-range communication network at a site. It further comprises a processor and a memory storing instructions that, when executed by the processor, cause the on-site device to: establish a communication connection with an EVSE of the one or more EVSEs and interface to the EVSE via a programmable logic controller (PLC) on a control pilot to perform diagnostics to locally recover charging operation of the one or more EVSEs, further aid in local or remote maintenance.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates an on-site device configured to be used with networked Electric Vehicle Supply Equipments (EVSEs) for an off-line EVSE configuration via diagnosing and recovering in accordance with an embodiment of the present invention.

FIG. 2 illustrates a method for diagnosing networked Electric Vehicle Supply Equipments (EVSEs) with an on-site device in accordance with an embodiment of the present invention.

FIG. 3 illustrates an on-site device configured to be used with networked Electric Vehicle Supply Equipment (EVSEs) in accordance with an embodiment of the present invention.

### DETAILED DESCRIPTION

Various technologies that pertain to systems and methods that configure an offline EVSE via an on-site device configured to be used with networked Electric Vehicle Supply Equipment (EVSEs) are presented. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present invention, they are explained hereinafter with reference to implementation in illustrative embodiments. In particular, they are described in the context of an EVSE configuration management system and a method that can configure an offline EVSE. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

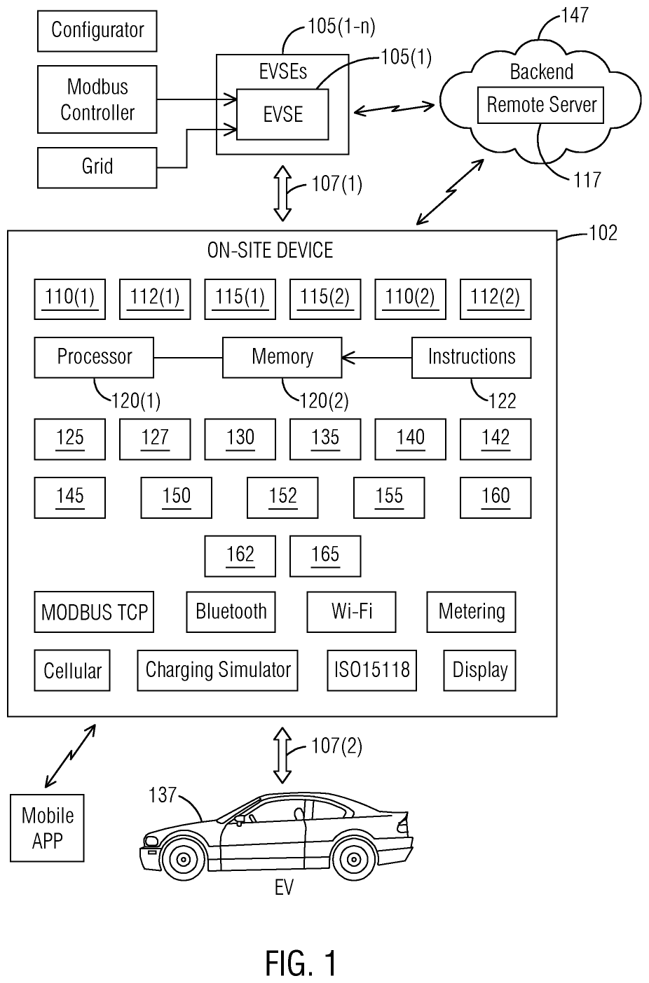

These and other embodiments of the on-site device configured to diagnose and recover networked Electric Vehicle Supply Equipment (EVSEs) according to the present disclosure are described below with reference to FIGS. 1-3 herein. Like reference numerals used in the drawings identify similar or identical elements throughout the several views. The drawings are not necessarily drawn to scale.

The term electric vehicle (EV), as used herein, refers to a motorized vehicle deriving locomotive power, either full-time or part-time, from an electric system on board the motorized vehicle. By way of non-limiting examples, an EV may be an electrically powered passenger vehicle for road use; an electric scooter; an electric fork lift; a cargo-carrying vehicle powered, full-time or part-time, by electricity; an off-road electrically powered vehicle; an electrically powered watercraft; etc.

The term electric vehicle supply equipment (EVSE), as used herein, refers to equipment by which an EV may be charged or recharged. An EVSE may comprise or be coupled to a computing system whereby service to the EV is provisioned, optionally, according to parameters. In some embodiments, values for the parameters are operator-selectable. Alternatively, or in addition, the values for the parameters may be automatically selected. An EVSE may comprise a means of providing cost accounting, and may further comprise a payment acceptance component. An EVSE may be installed at a home or residence of an owner/operator of an EV, at a place of business for an owner/operator of an EV, at a fleet facility for a fleet comprising one or more EVs, at a public charging station, etc. The present disclosure uses the terms EVSE and “charging station,” where for purposes of this disclosure, an EVSE is an example of a charging station.

An EVSE may be portable such that it can be brought by a user to various locations and used to charge an EV. For example, a user may install and use an EVSE at home to charge an EV. The user may then travel to a friend or family member's home, bringing the EVSE, and install and use the EVSE to charge the EV at the friend or family member's home.

The EVSE can be installed by connecting a plug of the EVSE to an electrical outlet at the installation location. The EVSE may then be used to deliver electricity to an EV for charging. However, electrical conditions may vary based on the installation location, which may impact EVSE performance, and the EVSE may need to be configured at different installation locations. Configuring the EVSE may be time and/or labor intensive, but improper configuring can be detrimental. For example, a maximum current delivered by the EVSE may vary based on the electrical conditions where the EVSE is installed, so the EVSE may need to be configured to determine a correct maximum current. Otherwise, use of the EVSE having an improper configuration may cause an electrical fault, tripping a circuit breaker of the installation location and disrupting charging. Accordingly, embodiments of the present disclosure relate to techniques for determining an EVSE configuration at each location where an EVSE is installed.

Consistent with one embodiment of the present invention, FIG. 1 represents an on-site device 102 configured to be used with networked Electric Vehicle Supply Equipments (EVSEs) 105(1-n) to diagnose and recover an offline Electric Vehicle Supply Equipment (EVSE) 105(1) for configuring the EVSE 105(1) in accordance with an embodiment of the present invention. The EVSE 105(1) has no network connectivity and is deployed in a location without network connectivity.

The on-site device 102 comprises a first coupler interface 107(1) configured to electrically connect the on-site device 102 to one or more EVSEs 105(1-n). The on-site device 102 further comprises a first communication interface 110(1) to connect the on-site device 102 to a short-range communication network 112(1) on a wired network 115(1) via Transmission Control Protocol/Internet Protocol (TCP/IP) or Remote Terminal Unit (RTU) or on a wireless network 115(2). The on-site device 102 further comprises a second communication interface 110(2) to connect the on-site device 102 to a long-range wireless communication network 112(2).

The on-site device 102 further comprises a processor 120(1) and a memory 120(2) storing instructions 122 that, when executed by the processor 120(1), cause the on-site device 102 to: establish a communication connection with the EVSE 105(1) and interface to the EVSE 105(1) via a programmable logic controller (PLC) 125 on a control pilot 127, Modbus RTU 130 or other near-field communication (NFC) 135, perform diagnostics to locally recover charging operation or network connectivity of one or more EVSEs 105(1-n) and further aid in remote maintenance. The step to interface to the EVSE 105(1) further comprises establish a control pilot communication between the on-site device 102 and the EVSE 105(1), simulate EV charging states 140, gather a status and diagnostic data 142 about the EVSE 105(1), evaluate network fallouts, evaluate a failure mode 145, connect to a backend 147, propagate data upstream and evaluate the EVSE data over a cellular network 150 or transmit the EVSE/EV data over a network for evaluation over a remote server 117.

The on-site device 102 further comprises a second coupler interface 107(2) configured to electrically connect the on-site device 102 to an electric vehicle (EV) 137. The on-site device 102 is configured to connect to the EVSE 105(1) through the first coupler interface 107(1) which allows for access to a control pilot signal 152 and load voltage lines 155 when the on-site device 102 simulates a charging scenario. The programmable logic controller (PLC) 125 communication utilizing a pilot line allows to perform authentication of the on-site device 102 similar to how the EV 137 is authenticated.

The on-site device 102 is configured to further request for fault data, network status, signal strength etc. The on-site device 102 access to local diagnostic logs is configured such that the logs can be shared via the cellular network 150 accessible on the on-site device 102 for further evaluation of a non-functioning unit. The on-site device 102 is configured to connect to the EVSE 105(1) via the RTU 130, the near-field communication (NFC) 135 (Bluetooth®, Radio-frequency identification (RFID) interface) and extract diagnostic information.

The on-site device 102 is configured to dynamically evaluate network issues causing loss of an Internet access to the EVSE 105(1) and attempt to restore a network connection 160 by restarting networking components on board and modifying a communication channel 162 in case of congestion as a recovery mechanism. The on-site device 102 is configured to be used in a breakout mode 165 inline with the EV 137.

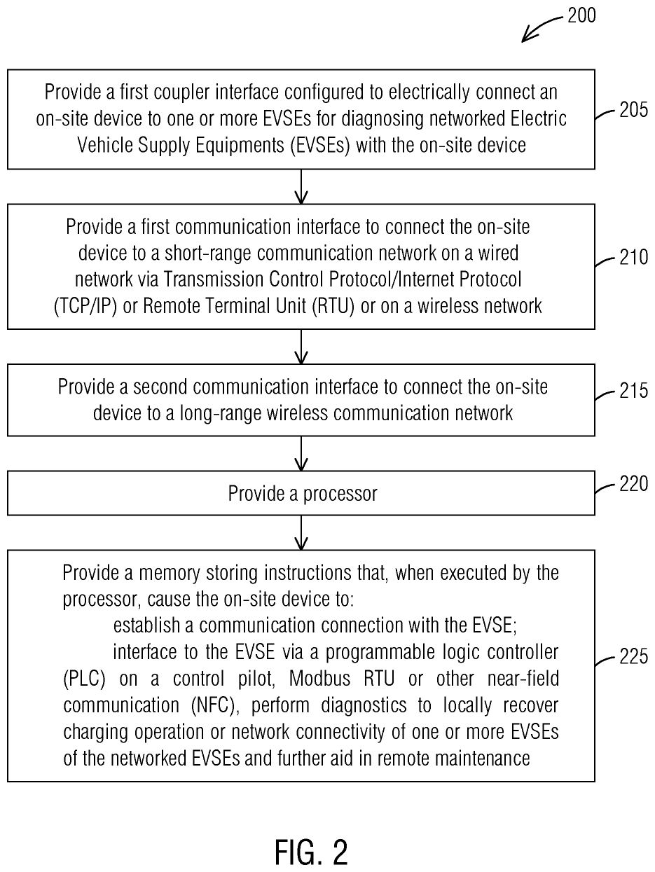

Referring to FIG. 2, it illustrates a method 200 for diagnosing the networked Electric Vehicle Supply Equipments (EVSEs) 105(1-n) with the on-site device 102 in accordance with an embodiment of the present invention. Reference is made to the elements and features described in FIG. 1. It should be appreciated that some steps are not required to be performed in any particular order, and that some steps are optional.

The method 200 comprises a step 205 of providing the first coupler interface configured to electrically connect the on-site device 102 to one or more EVSEs 105(1-n). The method 200 further comprises a step 210 of providing the first communication interface to connect the on-site device 102 to the short-range communication network on the wired network via Transmission Control Protocol/Internet Protocol (TCP/IP) or Remote Terminal Unit (RTU) or on the wireless network.

The method 200 further comprises a step 215 of providing the second communication interface to connect the on-site device 102 to the long-range wireless communication network. The method 200 further comprises a step 220 of providing the processor. The method 200 further comprises a step 225 of providing the memory storing instructions that, when executed by the processor, cause the on-site device 102 to: establish a communication connection with the EVSE 105(1) and interface to the EVSE 105(1) via the programmable logic controller (PLC) on the control pilot, Modbus RTU or other near-field communication (NFC), perform diagnostics to locally recover charging operation or network connectivity of one or more EVSEs of the networked EVSEs 105(1-n) and further aid in remote maintenance.

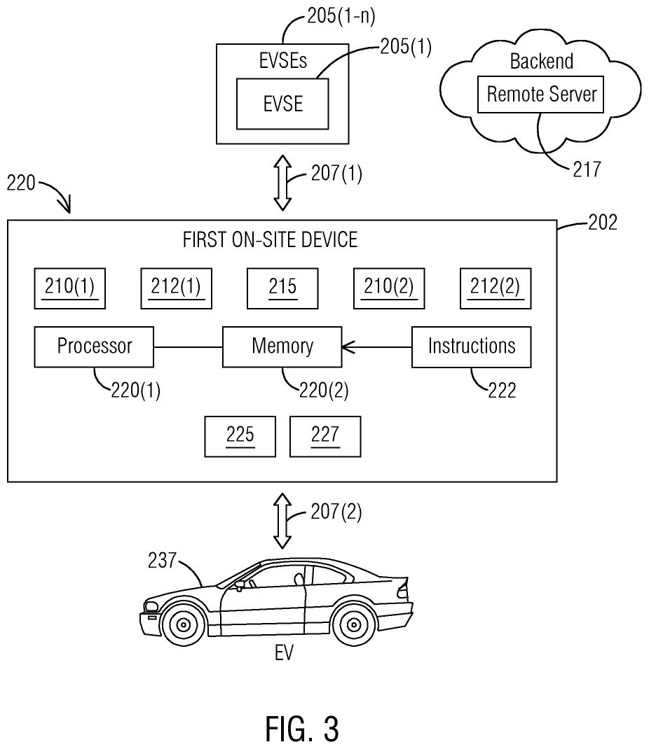

Turning now to FIG. 3, it illustrates a first on-site device 202 configured to be used with the networked Electric Vehicle Supply Equipment (EVSEs) 205(1-n) in accordance with an embodiment of the present invention. The first on-site device 202 comprises a first interface 207(1) configured to electrically connect the on-site device 202 to one or more EVSEs of the networked EVSEs 205(1-n). The first on-site device 202 further comprises a first communication interface 210(1) to connect the first on-site device 202 to a long-range communication network 212(1) to allow transfer of diagnostic data 215 to a remote server 217. The first on-site device 202 further comprises a second communication interface 210(2) to connect the first on-site device 202 to a short-range communication network 212(2) at a site 220.

The first on-site device 202 further comprises a processor 220(1) and a memory 220(2) storing instructions 222 that, when executed by the processor 220(1), cause the first on-site device 202 to: establish a communication connection with an EVSE 205(1) of the one or more EVSEs and interface to the EVSE 205(1) via a programmable logic controller (PLC) 225 on a control pilot 227 to perform diagnostics to locally recover charging operation of the one or more EVSEs, further aid in local or remote maintenance. The first on-site device 202 further comprises a second interface 207(2) configured to electrically connect the first on-site device 202 to an electric vehicle (EV) 237.

While a design based on a physical coupler is described here a range of one or more other electrical couplings are also contemplated by the present invention. For example, other electrical couplings may be implemented based on one or more features presented above without deviating from the spirit of the present invention.

The techniques described herein can be particularly useful for an inline use configuration of a diagnostic tool or device. While particular embodiments are described in terms of an inline diagnostic tool or device, the techniques described herein are not limited to such inline diagnostic tool or device but can also be used with other types of tools or devices.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. An on-site device configured to be used with networked Electric Vehicle Supply Equipments (EVSEs), the on-site device comprising:
a first coupler interface configured to electrically connect the on-site device to one or more EVSEs;
a first communication interface to connect the on-site device to a short-range communication network on a wired network via Transmission Control Protocol/Internet Protocol (TCP/IP) or Remote Terminal Unit (RTU) or on a wireless network;
a second communication interface to connect the on-site device to a long-range wireless communication network;
a processor; and
a memory storing instructions that, when executed by the processor, cause the on-site device to:
establish a communication connection with the EVSE; and
interface to the EVSE via a programmable logic controller (PLC) on a control pilot, Modbus RTU or other near-field communication (NFC), perform diagnostics to locally recover charging operation or network connectivity of one or more EVSEs of the networked EVSEs and further aid in remote maintenance.

2. The on-site device of claim 1, further comprising:
a second coupler interface configured to electrically connect the on-site device to an electric vehicle (EV).

3. The on-site device of claim 1, wherein the step to interface to the EVSE further comprising:
establish a control pilot communication between the on-site device and the EVSE;
simulate EV charging states;
gather a status and diagnostic data about the EVSE;
evaluate network fallouts;
evaluate a failure mode;
connect to a backend;
propagate data upstream; and
transmit EVSE/EV data over a network for evaluation over a remote server.

4. The on-site device of claim 1, wherein the on-site device is configured to connect to the EVSE through the first coupler interface which allows for access to a control pilot signal and load voltage lines when the on-site device simulates a charging scenario.

5. The on-site device of claim 4, wherein programmable logic controller (PLC) communication utilizing a pilot line allows to perform authentication of the on-site device similar to how the EV is authenticated.

6. The on-site device of claim 5, wherein the on-site device is configured to further request for fault data, network status, signal strength etc.

7. The on-site device of claim 6, wherein to the on-site device access to local diagnostic logs is configured such that the logs can be shared via a cellular network accessible on the on-site device for further evaluation of a non-functioning unit.

8. The on-site device of claim 1, wherein the on-site device is configured to connect to the EVSE via the RTU, near-field communication (NFC) (Bluetooth®, Radio-frequency identification (RFID) interface) and extract diagnostic information.

9. The on-site device of claim 1, wherein the on-site device is configured to dynamically evaluate network issues causing loss of an Internet access to the EVSE and attempt to restore a network connection by restarting networking components on board and modifying a communication channel in case of congestion as a recovery mechanism.

10. The on-site device of claim 1, wherein the on-site device is configured to be used in a breakout mode inline with the EV.

11. A method for diagnosing networked Electric Vehicle Supply Equipments (EVSEs) with an on-site device, the method comprising:
providing a first coupler interface configured to electrically connect the on-site device to one or more EVSEs;
providing a first communication interface to connect the on-site device to a short-range communication network on a wired network via Transmission Control Protocol/Internet Protocol (TCP/IP) or Remote Terminal Unit (RTU) or on a wireless network;
providing a second communication interface to connect the on-site device to a long-range wireless communication network;
providing a processor; and
providing a memory storing instructions that, when executed by the processor, cause the on-site device to:
establish a communication connection with the EVSE; and
interface to the EVSE via a programmable logic controller (PLC) on a control pilot, Modbus RTU or other near-field communication (NFC), perform diagnostics to locally recover charging operation or network connectivity of one or more EVSEs of the networked EVSEs and further aid in remote maintenance.

12. The method of claim 11, further comprising:
providing a second coupler interface configured to electrically connect the on-site device to an electric vehicle (EV).

13. The method of claim 11, wherein the step to interface to the EVSE further comprising:
establish a control pilot communication between the on-site device and the EVSE;
simulate EV charging states;
gather a status and diagnostic data about the EVSE;
evaluate network fallouts;
evaluate a failure mode;
connect to a backend;
propagate data upstream; and
transmit EVSE/EV data over a network for evaluation over a remote server.

14. The method of claim 11, wherein the on-site device is configured to connect to the EVSE through the first coupler interface which allows for access to a control pilot signal and load voltage lines when the on-site device simulates a charging scenario.

15. The method of claim 14, wherein programmable logic controller (PLC) communication utilizing a pilot line allows to perform authentication of the on-site device similar to how the EV is authenticated.

16. The method of claim 15, wherein the on-site device is configured to further request for fault data, network status, signal strength etc.

17. The method of claim 16, wherein to the on-site device access to local diagnostic logs is configured such that the logs can be shared via a cellular network accessible on the on-site device for further evaluation of a non-functioning unit.

18. The method of claim 11, wherein the on-site device is configured to connect to the EVSE via the RTU, near-field communication (NFC) (Bluetooth®, Radio-frequency identification (RFID) interface) and extract diagnostic information,
wherein the on-site device is configured to dynamically evaluate network issues causing loss of an Internet access to the EVSE and attempt to restore a network connection by restarting networking components on board and modifying a communication channel in case of congestion as a recovery mechanism, and
wherein the on-site device is configured to be used in a breakout mode inline with the EV.

19. An on-site device configured to be used with networked Electric Vehicle Supply Equipment (EVSEs), the on-site device comprising:
a first interface configured to electrically connect the on-site device to one or more EVSEs of the networked EVSEs;
a first communication interface to connect the on-site device to a long-range communication network to allow transfer of diagnostic data to a remote server;
a second communication interface to connect the on-site device to a short-range communication network at a site;
a processor; and
a memory storing instructions that, when executed by the processor, cause the on-site device to:
establish a communication connection with an EVSE of the one or more EVSEs; and
interface to the EVSE via a programmable logic controller (PLC) on a control pilot to perform diagnostics to locally recover charging operation of the one or more EVSEs, further aid in local or remote maintenance.

20. The on-site device of claim 19, further comprising:
a second interface configured to electrically connect the on-site device to an electric vehicle (EV).
